(19) United States
(12) Patent Application Publication
(10) Pub. No.: US 2017/0039626 A1
(43) Pub. Date: Feb. 9, 2017

(54) METHODS AND SYSTEMS FOR FACILITATING THE DISTRIBUTION OF VIRTUAL COLLECTABLES

(71) Applicant: MICHEL ENERGY, INC., Solvang, CA (US)

(72) Inventor: Chuck Michel, Solvang, CA (US)

(21) Appl. No.: 15/232,774

(22) Filed: Aug. 9, 2016

Related U.S. Application Data
(63) Continuation of application No. PCT/US2015/015289, filed on Feb. 10, 2015.
(60) Provisional application No. 61/938,092, filed on Feb. 10, 2014.

(51) Int. Cl. G06Q 30/06; G06Q 50/00; G06F 3/0482; H04L 29/06

(52) U.S. Cl. CPC G06Q 30/0641; H04L 63/10; G06Q 50/01; G06F 3/0482

(57) ABSTRACT

A method for collecting virtual collectables comprises providing a system that facilitates the exchange and storage of virtual collectables, in which at least some of the virtual collectables correspond to physical objects. Next, one or more virtual collectables are presented to a user on a user interface of an application associated with the system. A selection for a virtual collectable from the one or more virtual collectables is then received from the user, and the virtual collectable selected by the user is exchanged for an item of value to the user. The virtual collectable is then stored in a virtual storage area of the system that is dedicated to the user.

### CROSS-REFERENCE

This application is a continuation application of PCT International Application No. PCT/US2015/015289, filed Feb. 10, 2015, which claims priority to U.S. Provisional Patent Application No. 61/938,092, filed Feb. 10, 2014, each of which is entirely incorporated herein by reference.

### BACKGROUND

A collectable, such as a collector's item, is an object regarded as being of value or interest to a collector. A collectable is not necessarily monetarily valuable or antique. There are many different types of collectables. For instance, an antique may be a collectable that is old; a curio may be a small, usually fascinating or unusual item sought after by collectors; and a manufactured collectable may be an item that is made specifically for people to collect.

A manufactured collectable may include manufactured items that use the terms special edition, limited edition and variants such as deluxe edition, collector's edition and others. Categorizing manufactured collectables in this way may be used as a marketing incentive for various kinds of products, including originally published products related to the arts, such as books, prints or recorded music. Additionally, collectables may include films, cars, fine wine, and other collectables. In examples of manufactured collectables, a limited edition may be restricted in the number of copies produced, although in fact the number may be very low or very high. In another example, a special edition of a manufactured collectable may imply that there is extra material of some kind included in the manufactured collectable.

Manufacturers and retailers may use collectables in a number of ways to increase sales. For example, licensed collectables based on intellectual property, such as images, characters and logos from literature, music, movies, radio, television, and video games, may be produced as manufactured collectables. A large subsection of licensing may include advertising, brand name, and character collectables. Another use of collectables in retail may be in the form of prizes. For example, items of nominal value may be packaged with or included in the price of a retail product at no additional cost. Another use of collectables in retail may be with the use of premiums, such as items that can be ‘purchased’ by redeeming coupons, box tops, or proofs of purchase from the product along with a small fee to cover shipping and handling.

Another important field of collecting is memorabilia, which may include collectables related to a person, organization, event or media, including t-shirts, posters, and numerous other collectables marketed to fans. Memorabilia may also include ephemera from historical, media, or entertainment events, items that were meant to be thrown away but are2 saved by fans and accumulated by collectors.

Collectables may have limited supply and may be sought for a variety of reasons, including a possible increase in value over time. In a financial sense, collectables may be viewed as a hedge against inflation. Over time, their value can also increase as they become increasingly rare due to loss, damage or destruction.

### SUMMARY

While many types of collectables are presently available, recognized herein are various limitations with such collectables. For example, some collectables are physically inaccessible to many users because they are part of a private collection. Rare automobiles, rare coins, famous works of art, and the like are sometimes inaccessible to any except friends, family, and acquaintances of those who own them. Even if the owners would desire to make the collectables available for public viewing, it is difficult to logistically display limited, rare objects in a way that protects the objects from theft or tarnish. However, there are many rare objects that are of great interest to users that simply are not technically accessible for viewing or for purchase.

Even if a user does have access to purchase a collectable, some users may not be in a position to purchase a special edition or limited edition collectable due at least in part to the potential high cost associated with such a purchase. For example, a rare collectable automobile can cost hundreds of thousands, if not millions, of dollars. Another issue with present collectables is that a user may need to have physical space or real estate to store such collectables, which adds to the cost associated with owing collectables. For example, a user that wishes to own a rare automobile may need to have a garage to store the automobile. Additionally, having a garage to store a rare automobile may require security and an environment that is tailored to storing the automobile in a manner that minimizes environmental degradation.

The present disclosure provides systems and methods that enable users to acquire, store and distribute virtual collectables that correspond to a real world object. The real world object may have appeal to the user. For example, the user may purchase an automobile virtual collectable that is generated from a real world automobile. The virtual collectable can be stored in a virtual storage area, such as, for example, a virtual garage for automobiles. Virtual storage areas can be customized by the user or upgraded in exchange for an item of value to the user. As such, the user is able to own a virtual replica or representation that corresponds to a real world item of interest to the user that the user may not otherwise be able to access. Additionally, the virtual collectable may be updated to reflect changes in the real world object over time. For example, if a rare automobile is updated to change its paint color, the virtual object may be updated to express this changed characteristic as well.

The virtual storage area can be dedicated to the user and restricted to other users. For example, the user may need to provide an access code to enter the virtual storage to view virtual collectables. For example, the access code may comprise identifying information and a password. Additionally, the user may grant other users access to the virtual storage area. In this way, the virtual storage area may provide limited access to virtual collectables.

The present disclosure also provides systems that enable the user to store a virtual collectable and manipulate the virtual collectable. A virtual collectable can then be sold or traded in exchange for an item of value, such as another virtual collectable or currency.

An aspect of the present disclosure provides a method for collecting virtual collectables. The method comprises providing a system that facilitates the exchange and storage of virtual collectables, wherein at least some of the virtual collectables correspond to physical objects. The method also comprises presenting to a user one or more virtual collectables on a user interface of an electronic display of an electronic device of the user. Additionally, the method comprises receiving from the user a selection for a virtual collectable from the one or more virtual collectables. The method also comprises exchanging the virtual collectable selected by the user for an item of value to the user. Further, the method comprises storing the virtual collectable in a virtual storage area of the system, wherein the virtual storage area is dedicated to the user.

In some embodiments, the virtual collectable is of limited supply. In some embodiments, the item of value is money or another virtual collectable. Additionally, in some embodiments the method further comprises receiving input from the user on the user interface to customize a visual representation of the virtual storage area.

In another aspect, a system for storing virtual collectables of limited supply for ready access by a user is provided. The system comprises a database of virtual collectables that includes (i) a limited supply of virtual collectables corresponding to physical objects, and (ii) a virtual storage area dedicated to store one or more virtual collectables selected among the limited supply of virtual collectables by the user. The system also comprises a communications interface that is in network communication with an electronic device of the user. Additionally, the system comprises a computer processor coupled to the database and the communications interface and programmed to (i) retrieve one or more virtual collectables from the database, (ii) provide the one or more virtual collectables via the communications interface for display on a user interface of an electronic display of the electronic device of the user, (iii) receive from the user a selection for a virtual collectable among the one or more virtual collectables, (iv) exchange the virtual collectable selected by the user for an item of value to the user, and (v) store the virtual collectable in the virtual storage area, thereby enabling the user to store the virtual collectable of limited supply for ready access by the user.

In some embodiments, the database includes virtual storage areas for a plurality of users, each accessibly by a select user and not other users among the plurality of users. In some embodiments, the item of value is money or another virtual collectable. In some embodiments, the virtual storage area is customizable by the user. In some embodiments, the virtual collectable has a corresponding graphical representation for display on the user interface, wherein the graphical representation includes a graphical element that is indicative of the limited supply of the virtual collectable. Additionally, in some embodiments the graphical element is a first number and a second number, wherein the first number corresponds to the virtual collectable provided to the user and the second number corresponds to the total number of the virtual collectables that are available as part of the limited supply of the virtual collectable.

Additional aspects and advantages of the present disclosure will become readily apparent to those skilled in this art from the following detailed description, wherein illustrative embodiments of the present disclosure are shown and described. As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings (also “figure” and “FIG.” herein), of which:

FIG. 1 shows a graphical user interface (GUI) that comprises a virtual storage area;

FIG. 2 shows another GUI that comprises a virtual storage area; and

FIG. 3 shows a computer system for facilitating the purchase, distribution and storage of virtual collectables.

### DETAILED DESCRIPTION

While various embodiments of the invention have been shown and described herein, it will be obvious to those skilled in the art that such embodiments are provided by way of example only. Numerous variations, changes, and substitutions may occur to those skilled in the art without departing from the invention. It should be understood that various alternatives to the embodiments of the invention described herein may be employed.

The term “collectable,” as used herein, generally refers to an object regarded as being of value or interest to a user that collects collectables (also “collector” here). A collectable is a physical object. A collectable can have monetary value to the collector. There are numerous types of collectables and terms to denote those types. For example, an antique is a collectable that is old.

The term “virtual collectable,” as used herein, generally refers to a virtual object that corresponds to an object or item that may have a physical counterpart. A virtual collectable can be an electronic object, such as a user interface (UI) object (e.g., textual object, image object, audible object and/or video object, and combinations thereof), which can correspond to a physical item, such as an automobile existing in the real world. For example, an electronic icon in the shape of an automobile (e.g., Ferrari®) displayed in a UI can correspond to a physical version of the automobile. A virtual collectable can be of limited supply. In another example, a virtual collectable is a real estate item (e.g., a piece of land) that may be among a limited number of lots.

The present disclosure provides methods and systems for generating, collecting (or acquiring), storing and distributing virtual collectables. Virtual collectables can be electronic objects that correspond to actual or real world objects. In some cases, they can derive their value from (i) corresponding to actual or real world objects, and/or (ii) being of limited supply and or distribution (e.g., geographic distribution). In an example, a virtual collectable is a virtual car that is an electronic replica of a car, such as a fancy car of a famous actor. The virtual car can be presented in the form of an icon. The icon can have an indication (e.g., car 1 out of 50) that is indicative of the limited supply of the virtual car.

A virtual collectable can correspond to a physical (real world) object, such as a vehicle of a famous individual or home of a famous individual (e.g., movie star). Additionally or alternatively, a virtual collectable can correspond to an imaginary object, such as an imaginary car that may not have a physical counterpart.

A virtual collectable can be generated such that it is of limited supply. For example, the virtual collectable can have a supply of fifty units. These fifty units may be distributed to the users by allowing the users to have access to the virtual collectable. For example, each of the users who have acquired access to the virtual collectable may receive the same access code that is associated with the virtual object. Alternatively, each of the fifty users may receive an access code that is unique to the user so that the user may access the virtual collectable.

Upon distribution of the 50 units to users, the virtual collectable may no longer be available for purchase. In some cases, the virtual collectable can be traded with another user who obtained the virtual collectable of limited supply. If a user trades his virtual collectable for an item of value, such as money, the buyer may be issued a new, unique access code and the user's access code may be invalidated.

A user can store virtual collectables in an electronic system that is programmed or otherwise configured to store virtual collectables, as described elsewhere herein. The electronic system can provide the user with a storage environment (e.g., vault) for the user to store virtual collectables collected by the user. The vault can have a user interface that enables the user to arrange virtual collectables of the user as desired. The user interface can be a graphical user interface (GUI), which can have graphical elements that facilitate storage and display of the virtual collectables of the user.

In some cases, virtual collectables can be generated, stored and distributed using applications that can be presented on various systems, such as social networks, games, or games within games. A virtual collectable can be acquired, stored, and distributed by way of an application that is executed as a standalone application, or an application as part of a larger application, such as a game or social network. A social network (e.g., Facebook®, Google+®, LinkedIn® or Tumblr®) can have an application (or “app”) that enables a user to acquire, store, and distribute virtual collectables.

In some examples, the application can have a limited number of images of rare collectables. The images of rare collectables may have a corresponding graphical representation for display on the user interface, where the graphical representation includes a graphical element that is indicative of the limited supply of the virtual collectable. In particular, the graphical element may have a first number that corresponds to the virtual collectable and a second number that corresponds to the total number of virtual collectables that are available as part of the limited supply of the virtual collectables. Additionally, the rare collectables may have a special logo presented on an image. Each virtual collectable may be privatized to an application, and in some cases the user that owns the virtual collectable. The application can provide the user with a virtual storage area to store the virtual collectables of the user. A virtual collectable can have a logo that can enable the virtual collectable to be displayed in the user's storage area (e.g., virtual show room or show case).

Virtual collectables can be distributed between or among users. Users can buy and trade virtual collectables from one another. A user can bid for the virtual collectable of another user as part of a bidding process. A user can regulate which other users can view the virtual collectables of the user, such as by way of share settings or preferences, or by inviting a user to view a virtual storage area or a subset thereof of the user.

Virtual collectables can be of limited supply. When the supply of a given virtual collectable has run out, a user may not be able to purchase the virtual collectable from the system, but may reach out to other users who may have the virtual collectable to gain access to the virtual collectable and/or to acquire the virtual collectable.

For instance, a seller having the virtual collectable can offer the virtual collectable to a buyer at a price that may be determined by the seller. If the buyer accepts the offer, the system can transfer the virtual collectable to the buyer and charge a fee (e.g., a 20% brokerage or transfer fee) to process the transfer. The virtual collectable can then appear in a virtual storage area of the buyer.

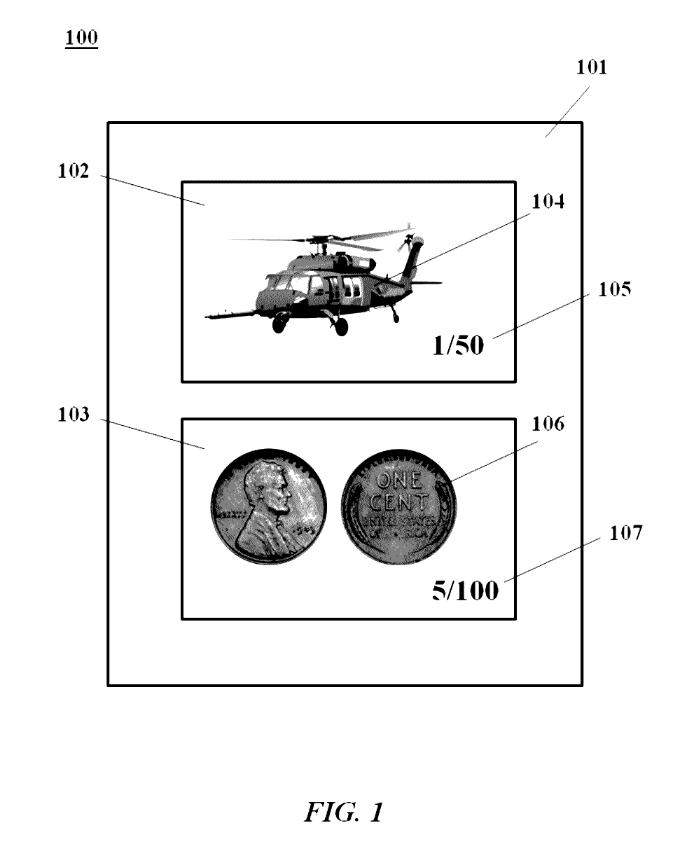

Virtual collectables can be presented in a virtual storage area on a user interface (UI) of an electronic device of a user, such as a graphical user interface (GUI). FIG. 1 shows a GUI 100 comprising a virtual storage area 101. The virtual storage area 101 includes a first display location 102 and a second display location 103. The first display location 102 includes a first virtual collectable 104 that corresponds to a helicopter. The first display location 102 also includes an indication 105 of the limited supply of the first virtual collectable 104. In the illustrated example, the first virtual collectable 104 is the first unit purchased out of fifty available units (“1/50”). The second display location 103 includes a second virtual collectable 106 that corresponds to a 1943 United States one cent coin (front and back views). The second display location 103 also includes an indication 107 of the limited supply of the second virtual collectable 106. In the illustrated example, the second virtual collectable 106 is the fifth unit purchased out of one hundred available units (“5/100”).

A virtual collectable can be generated from one or more corresponding real world physical objects, such as those seen in FIG. 1. The first virtual collectable 104 can be generated from a real world helicopter, and the second virtual collectable 106 can be generated from a real world 1943 one cent coin. As such, both virtual collectables provide a user access to physical objects that may be difficult to see in-person. For example, the coin may be owned by a collector. Additionally, the helicopter may only be closely inspected by a professional helicopter pilot, engineer, or passenger. By providing the virtual collectable of the helicopter, a user may inspect the coin or helicopter in depth without having to gain access to the physical objects.

Virtual collectables can be generated by a seller and made available to buyers. For example, a seller with access to a real world 1943 United States one cent coin may capture an image of the coin and generate a virtual collectable from the image. The coin virtual collectable may include a graphical representation of the coin, which can be a substantially exact reproduction of the coin or a graphical rendition of the coin. The virtual collectable can be associated with a graphical representation of the virtual collectable and a digital certificate that provides an indication of the limited quantity (if any) of the virtual collectable and the corresponding real world object that the virtual collectable was generated from. The seller can then make the virtual collectable available on the system, in some cases at limited quantity.

A virtual storage area can be customizable by a user of the system. A user can have one or more virtual storage areas, and the user can keep a virtual storage area private (e.g., only accessible by the user) or public (e.g., accessible by all users), or set access restrictions for which others users (e.g., friends of the user) may access the virtual storage area. A user can customize a virtual storage area with a shape, color and distribution of virtual collectables as desired. In particular, a user may provide a virtual storage area having multiple walls, multiple rooms, and multiple areas to display virtual collectables. Further, the virtual storage area does not need to be restrained to physical laws. For example, a user may generate a virtual storage area modeled on an M. C. Escher painting, where walls and rooms are provided by the connections between them may not be physically possible in the real world.

In some examples, the virtual storage area can be configured in accordance the genre of virtual collectables that are stored in the virtual storage area. For example, the virtual storage area may be designed as a den, such that virtual collectables may be presented on shelves and a mantle within the den. Decorations, such as wood paneling, may be added to accent the room and provide an atmosphere that fits the tastes and desires of the user. Alternatively, the virtual storage area may be designed as a garage for automobile virtual collectables. The garage may have car ports that are decorated with colors and decals to compliment the automobile virtual collectable associated with the car port.

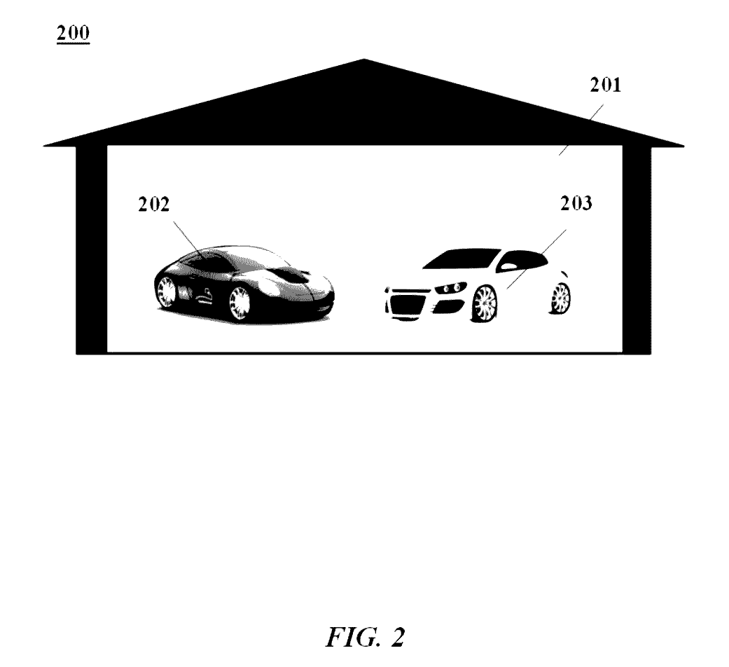

Accordingly, FIG. 2 shows a user interface 200 comprising a virtual storage area 201 for automobile virtual collectables. In particular the virtual storage area 201 looks like a garage. The virtual storage area 201 includes a first virtual collectable 202 and a second virtual collectable 203, each of which is designed to correspond to an automobile with certain characteristics. Each of virtual collectables 202 and 203 can be of limited supply and may be made available by a seller who had access to a real world automobile.

A virtual collectable can be generated from a real world object, which can be an object of appeal to a buyer or prospective buyer. For example, an automobile virtual collectable that looks like a fancy automobile may correspond to an exact real world automobile. In an example of generating a virtual object, a physical object may be identified. The physical object may be identified by a request from a user, such as a user within a limited audience. The physical object may correspond to a rare automobile that is owned by a celebrity. Based on the physical object, a virtual collectable that includes characteristics of the physical object may be generated. Once the virtual collectable is generated, the virtual collectable may be provided to a limited audience through a system that facilitates the storage of the virtual collectable and exchange of the virtual collectable for an item of value. For example, the virtual collectable may be provided to members of a limited audience through a virtual storage area that requires the limited audience to provide an access code. Additionally, if one or more changed characteristics of the physical object are identified, the virtual collectable may be updated to reflect the one or more changed characteristics of the physical object.

In some examples, the seller can make the corresponding virtual collectable available to buyers and let the buyers know that the virtual collectable has been generated from a real world automobile. This can aid in generating interest in the virtual collectable.

A virtual collectable can be purchased by a buyer from a seller for an item of value to the buyer. For example, the buyer can provide currency (e.g., real currently or virtual currency) in exchange for the virtual collectable. As another example, the buyer can exchange the virtual collectable for another virtual collectable (e.g., exchange a virtual automobile of limited supply for a virtual helicopter of limited supply).

The value of a virtual collectable can be a function of the supply of the virtual collectable. For example, with reference to FIG. 1, the value of the second virtual collectable 106 can increase as the supply of the second collectable 106 decreases. In FIG. 1, the second virtual collectable 106 is number five out of a total of one hundred units of the second virtual collectable 106. If ninety five units of the second virtual collectable 106 remain, then the value of the second virtual collectable 106 may be less than if only five units of the second virtual collectable 106 remain.

Virtual collectables of the present disclosure may have various features. Virtual collectables can be acquired, stored and distributed in an on-line collectable environment with a limited number of collectables. Virtual collectables may also be uniquely logoed. Additionally, virtual collectables can be generated from various real world objects, such as, for example, coins, stamps, toys, artwork, and vehicles. This can provide a virtual collectable a degree of exclusivity to the limited number of each item.

A virtual collectable can be displayed in a virtual storage area with a custom animation. For example, an automobile virtual collectable can be displayed in a virtual garage and set to rotate on a UI of a user that owns the virtual collectable. The virtual collectable may also be manipulated by the user. For example, the virtual collectable may be enlarged or flipped or otherwise viewed in a way that allows the user to interact with the virtual collectable. The virtual collectable may have an image that is dynamically altered to make it more visually appealing to the user. For example, a color shading or intensity of the image of the virtual collectable may be changed dynamically.

A user can access a virtual collectable to access additional information that may be relevant to the virtual collectable, such as a physical object that corresponds to the virtual collectable, a present or potential value of the virtual collectable, an assessment of a demand for the virtual collectable (including number of other virtual collectable in circulation), and specifications of the virtual collectable. For example, if the virtual collectable is a fancy automobile, the user can access the virtual collectable to learn more about the virtual collectable, such as the specifications of the fancy automobile (e.g., date built, availability or demand, and engine power).

A variety of upgrades can be provided to the user to stylize and enlarge the display of a virtual collectable. For example, the system can provide the user the option to purchase a stylized virtual storage space, such as, for example a garage for automobile virtual collectables or a stylized display case for coin virtual collectables. When the limited number of collectable item, or upgrade, is sold and is no loner available, a user may be directed to contact another user that owns the collectable item or upgrade to acquire the item or upgrade. The user can purchase the collectable item or upgrade from the other user by exchanging an item of value with the other user, such as another virtual collectable or currency. In such a case, the system can facilitate the transaction and request a transaction fee from the user, the other user, or both.

A user can have the ability to manipulate a virtual collectable both within and outside of a virtual storage area. As an example, a user may want to spin and look at the backside of a rare $30,000 penny or see the back side of a rare $1 million baseball card.

The system can enable users to use their virtual collectables in games and various social settings. For example, the system, using an application that is configured to enable manipulation and virtual use of a virtual collectable, can allow a user that owns an automobile virtual collectable to take the automobile on a drive around a virtual track, such as, for example, a simulated drive at a famous race track.

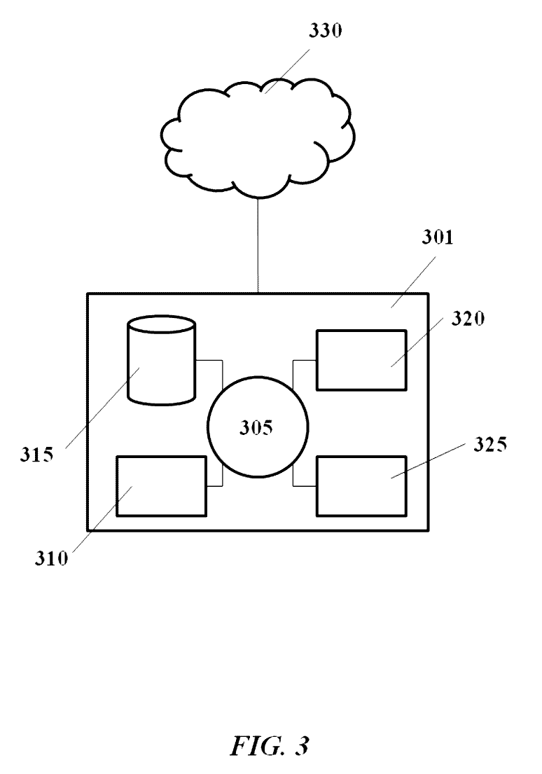

The present disclosure also provides computer control systems that are programmed to implement methods of the disclosure. FIG. 3 shows a computer system 301 that is programmed or otherwise configured for the generation, collection, acquisition and distribution of virtual collectables. The computer system 301 can regulate various aspects of virtual collectables of the present disclosure, such as, for example, acquiring (e.g., buying) virtual collectables, storing virtual collectables, and providing access to virtual collectables having a limited quantity.

The computer system 301 includes a central processing unit (CPU, also “processor” and “computer processor” herein) 305, which can be a single core or multi core processor, or a plurality of processors for parallel processing. The computer system 301 also includes memory or memory location 310 (e.g., random-access memory, read-only memory, flash memory), electronic storage unit 315 (e.g., hard disk), communication interface 320 (e.g., network adapter) for communicating with one or more other systems, and peripheral devices 325, such as cache, other memory, data storage and/or electronic display adapters. The memory 310, storage unit 315, interface 320 and peripheral devices 325 are in communication with the CPU 305 through a communication bus (solid lines), such as a motherboard. The storage unit 315 can be a data storage unit (or data repository) for storing data. The computer system 301 can be operatively coupled to a computer network (“network”) 330 with the aid of the communication interface 320. The network 330 can be the Internet, an internet and/or extranet, or an intranet and/or extranet that is in communication with the Internet. The network 330 in some cases is a telecommunication and/or data network. The network 330 can include one or more computer servers, which can enable distributed computing, such as cloud computing. The network 330, in some cases with the aid of the computer system 301, can implement a peer-to-peer network, which may enable devices coupled to the computer system 301 to behave as a client or a server.

The CPU 305 can execute a sequence of machine-readable instructions, which can be embodied in a program or software. The instructions may be stored in a memory location, such as the memory 310. Examples of operations performed by the CPU 305 can include fetch, decode, execute, and writeback.

The storage unit 315 can store files, such as drivers, libraries and saved programs. The storage unit 315 can store programs generated by users and recorded sessions, as well as output(s) associated with the programs. The storage unit 315 can store user data, e.g., user preferences and user programs. The computer system 301 in some cases can include one or more additional data storage units that are external to the computer system 301, such as located on a remote server that is in communication with the computer system 301 through an intranet or the Internet.

The computer system 301 can communicate with one or more remote computer systems through the network 330. For instance, the computer system 301 can communicate with a remote computer system of a user (e.g., operator). Examples of remote computer systems include personal computers (e.g., portable PC), slate or tablet PC's (e.g., Apple® iPad, Samsung® Galaxy Tab), telephones, Smart phones (e.g., Apple® iPhone, Android-enabled device, Blackberry®), or personal digital assistants. The user can access the computer system 301 via the network 330.

Methods as described herein can be implemented by way of machine (e.g., computer processor) executable code stored on an electronic storage location of the computer system 301, such as, for example, on the memory 310 or electronic storage unit 315. The machine executable or machine readable code can be provided in the form of software. During use, the code can be executed by the processor 305. In some cases, the code can be retrieved from the storage unit 315 and stored on the memory 310 for ready access by the processor 305. In some situations, the electronic storage unit 315 can be precluded, and machine-executable instructions are stored on memory 310.

The code can be pre-compiled and configured for use with a machine have a processor adapted to execute the code, or can be compiled during runtime. The code can be supplied in a programming language that can be selected to enable the code to execute in a pre-compiled or as-compiled fashion.

Aspects of the systems and methods provided herein, such as the computer system 301, can be embodied in programming. Various aspects of the technology may be thought of as “products” or “articles of manufacture” typically in the form of machine (or processor) executable code and/or associated data that is carried on or embodied in a type of machine readable medium. Machine-executable code can be stored on an electronic storage unit, such memory (e.g., read-only memory, random-access memory, flash memory) or a hard disk. “Storage” type media can include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer into the computer platform of an application server. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to non-transitory, tangible “storage” media, terms such as computer or machine “readable medium” refer to any medium that participates in providing instructions to a processor for execution.

Hence, a machine readable medium, such as computer-executable code, may take many forms, including but not limited to, a tangible storage medium, a carrier wave medium or physical transmission medium. Non-volatile storage media include, for example, optical or magnetic disks, such as any of the storage devices in any computer(s) or the like, such as may be used to implement the databases, etc. shown in the drawings. Volatile storage media include dynamic memory, such as main memory of such a computer platform. Tangible transmission media include coaxial cables, copper wire and fiber optics, including the wires that comprise a bus within a computer system. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a ROM, a PROM and EPROM, a FLASH-EPROM, any other memory chip or cartridge, a carrier wave transporting data or instructions, cables or links transporting such a carrier wave, or any other medium from which a computer may read programming code and/or data. Many of these forms of computer readable media may be involved in carrying one or more sequences of one or more instructions to a processor for execution.

The computer system 301 can include or be in communication with an electronic display that comprises a user interface (UI) for providing, for example, virtual collectables. Examples of UI's include, without limitation, a graphical user interface (GUI) and web-based user interface.

### Example 1

A system that facilitates the acquisition, distribution and storage of virtual collectables presents virtual coins corresponding to rare coins on a graphical user interface (GUI) of an electronic display of a user. The virtual coins correspond to a 1943 one cent coin that was inadvertently stamped on a cooper planchete and left in a machine from previous year, a 1799 silver dollar, a 1969 S Lincoln one cent coin with a double die error, a 1933 Double Eagle, a 1794 “Flowing Hair” dollar, an 1804 Silver dollar, and a 1913 Lincoln head nickel. The virtual coins correspond to actual coins with the aforementioned characteristics, which typically sell for thousands or millions of dollars. The virtual coins are offered to the user at a price of $10 per virtual coin. The system has a limited supply of fifty of each of the virtual coins—for example, there are fifty virtual coins corresponding to the 1943 one cent coin and fifty virtual coins corresponding to the 1799 silver dollar. On the GUI, the user selects two quantities of a virtual coin corresponding to the 1943 one cent coin and one virtual coin corresponding to the 1799 silver dollar. The system processes the user's selection and charges the user $30 for three virtual coins. The system then provides the virtual coins in a virtual storage area of the system. The user accesses the virtual storage area and views the three virtual coins, and arranges (e.g., drags and drops) the virtual coins in a manner that is desired by the user.

The virtual storage area can be dedicated to the user and restricted to other users. For example, the user may need to provide an access code, such as a password, to enter the virtual storage and to view the three virtual coins.

### Example 2

A buyer purchases from a seller a first virtual collectable that corresponds to a first fancy car and a second virtual collectable that corresponds to a second fancy car. The purchase is facilitated by a computer system that is programmed for the acquisition, distribution and storage of virtual collectables, as described elsewhere herein. The seller makes it known to the buyer that the first and second virtual collectables are generated from real world fancy cars (e.g., which may be owned by a famous movie star), and that the first and second virtual collectables are of limited quantity. The buyer provides the seller currency in exchange for the first and second virtual collectables. Next, the system makes the first and second virtual collectables available in a virtual storage area of the buyer that has various graphical elements resembling an automobile garage (see, e.g., FIG. 2). The buyer then arranges the first and second virtual collectables in the garage in a manner that may approximate the buyer arranging real world automobiles in a real world garage.

While preferred embodiments of the present invention have been shown and described herein, it will be obvious to those skilled in the art that such embodiments are provided by way of example only. It is not intended that the invention be limited by the specific examples provided within the specification. While the invention has been described with reference to the aforementioned specification, the descriptions and illustrations of the embodiments herein are not meant to be construed in a limiting sense. Numerous variations, changes, and substitutions will now occur to those skilled in the art without departing from the invention. Furthermore, it shall be understood that all aspects of the invention are not limited to the specific depictions, configurations or relative proportions set forth herein which depend upon a variety of conditions and variables. It should be understood that various alternatives to the embodiments of the invention described herein may be employed in practicing the invention. It is therefore contemplated that the invention shall also cover any such alternatives, modifications, variations or equivalents. It is intended that the following claims define the scope of the invention and that methods and structures within the scope of these claims and their equivalents be covered thereby.

What is claimed is:

1. A method for collecting virtual collectables, comprising:
(a) providing a system that facilitates the exchange and storage of virtual collectables, wherein at least some of the virtual collectables correspond to physical objects;
(b) presenting to a user one or more virtual collectables on a user interface of an electronic display of an electronic device of the user;
(c) receiving from the user a selection for a virtual collectable from the one or more virtual collectables of (b);
(d) exchanging the virtual collectable selected by the user for an item of value to the user; and
(e) storing the virtual collectable in a virtual storage area of the system, wherein the virtual storage area is dedicated to the user.

2. The method of claim 1, wherein the virtual collectable is of limited supply.

3. The method of claim 1, wherein the item of value is money.

4. The method of claim 1, wherein the item of value is another virtual collectable.

5. The method of claim 1, wherein the virtual storage area is customizable by the user.

6. The method of claim 1, further comprising receiving input from the user on the user interface to customize a visual representation of the virtual storage area.

7. A system for storing virtual collectables of limited supply for ready access by a user, comprising:
a database of virtual collectables that includes (i) a limited supply of virtual collectables corresponding to physical objects, and (ii) a virtual storage area dedicated to store one or more virtual collectables selected among the limited supply of virtual collectables by the user;
a communications interface that is in network communication with an electronic device of the user; and
a computer processor coupled to the database and the communications interface and programmed to (i) retrieve one or more virtual collectables from the database; (ii) provide the one or more virtual collectables via the communications interface for display on a user interface of an electronic display of the electronic device of the user; (iii) receive from the user a selection for a virtual collectable among the one or more virtual collectables; (iv) exchange the virtual collectable selected by the user for an item of value to the user; and (v) store the virtual collectable in the virtual storage area, thereby enabling the user to store the virtual collectable of limited supply for ready access by the user.

8. The system of claim 7, wherein the database includes virtual storage areas for a plurality of users, each accessible by a select user and not other users among the plurality of users.

9. The system of claim 7, wherein the item of value is money.

10. The system of claim 7, wherein the item of value is another virtual collectable.

11. The system of claim 7, wherein the virtual storage area is customizable by the user.

12. The system of claim 7, wherein the virtual collectable has a corresponding graphical representation for display on the user interface, wherein the graphical representation includes a graphical element that is indicative of the limited supply of the virtual collectable.

13. The system of claim 12, wherein the graphical element is a first number and a second number, wherein the first number corresponds to the virtual collectable provided to the user and the second number corresponds to the total number of the virtual collectables that are available as part of the limited supply of the virtual collectables.

14. A method for providing a virtual collectable of limited supply for ready access by users, comprising:
(a) identifying a physical object;
(b) generating a virtual collectable that includes characteristics of the physical object;
(c) storing the virtual collectable generated in (b) in a memory location of a computer system that facilitates the storage of the virtual collectable and exchange of the virtual collectable for an item of value; and
(d) providing the virtual collectable to a limited audience through the computer system.

15. The method of claim 14, further comprising:
identifying one or more changed characteristics of the physical object; and
updating the virtual collectable to reflect the one or more changed characteristics of the physical object.

16. The method of claim 14, wherein the item of value is money.

17. The method of claim 14, wherein the physical object that is associated with the virtual collectable is identified by a request received from a user within the limited audience.

18. The method of claim 14, wherein the virtual collectable is provided to members of a limited audience through a virtual storage area that requires the limited audience to provide an access code.

19. The method of claim 18, wherein the access code is the same for each member of the limited audience.

20. The method of claim 18, wherein the access code is unique to each member of the limited audience.
